(19) United States
(12) Patent Application Publication
(10) Pub. No.: US 2022/0383267 A1
(43) Pub. Date: Dec. 1, 2022

(54) METHOD OF CREATING VIRTUAL OFFICE FOR REMOTE WORK

(71) Applicant: Charles Lap San CHAN, Taipei (TW)

(72) Inventor: Charles Lap San CHAN, Taipei (TW)

(21) Appl. No.: 17/398,505

(22) Filed: Aug. 10, 2021

(30) Foreign Application Priority Data
May 26, 2021 (CN) 110119125

(51) Int. Cl. G06Q 10/10; H04L 29/06

(52) U.S. Cl. CPC G06Q 10/1095; H04L 63/083

(57) ABSTRACT

In a method of creating virtual office for remote work, a virtual office identification code that is permanently exclusive to a user is generated. It is convenient for the user to provide clients to communicate with the user without changing the virtual office identification code from time to time. The method can limit the number of invited clients who can enter the electronic conference when the clients participate in the same electronic conference. Besides, the method can also individually identify the invited clients that enter the electronic conference.

This application claims priority of Application No. 110119125 filed in Taiwan on 26 May 2021 under 35 U.S.C. § 119; the entire contents of all of which are hereby incorporated by reference.

### BACKGROUND OF THE INVENTION

### Field of the Invention

The present invention relates to a method of creating virtual office for remote work, particularly to a method of creating virtual office that can generate a virtual office identification code permanently exclusive to a user.

### Description of the Related Art

In current business applications, there are many requirements for communicating remotely, such as holding conferences with customers in foreign countries, meeting with colleagues who are on business trips, and discussing projects with colleagues who work from home due to the pandemic, and so on.

The common remote communication or work from home are often carried out by means of holding online electronic conferences. The electronic conference can be a video conference, a voice conference, or a text conference. In the current common way to hold an online electronic conference, the user firstly obtains an electronic conference code and a random password provided by the online conference system. Then, the user forwards it to customers or colleagues, and asks them to enter the electronic conference with the electronic conference code and password.

However, the current online conference system provides a randomly generated set of an electronic conference code and a password every time when a conference is needed. In other words, customers or colleagues who participate in the electronic conference must receive a new set of a conference code and a password to participate the conference. In addition, all customers and colleagues use the same electronic conference code and password to enter the same electronic conference. As a result, the user cannot identify each member individually.

In view of the above description, there is still room for improvement in the application of online conference systems. Therefore, how to improve and provide quick and convenient solutions has become a research direction for those skilled in the art.

### SUMMARY OF THE INVENTION

The primary objective of the present invention is to provide a method of creating virtual office for remote work, which generates a virtual office identification code that is permanently exclusive to a user. It is convenient for the user to provide clients to communicate with the user without changing the virtual office identification code from time to time.

Another objective of the present invention is to provide a method of creating virtual office for remote work, which can also limits the number of invited clients who can enter the electronic conference when the clients participate in the same electronic conference.

Further objective of the present invention is to provide a method of creating virtual office for remote work, which individually identifies the invited clients entering the electronic conference.

To achieve the abovementioned objectives, the present invention provides a method of creating virtual office for remote work, which includes:
(A) generating a virtual office identification code that is permanently exclusive to a user, wherein the virtual office identification code is used to represent a virtual office;
(B) by the user, setting an access code; and
(C) creating an electronic conference based on the virtual office identification code and the access code, wherein the electronic conference is used to provide the user to communicate with the invited clients.

The features, advantages, or similar expressions mentioned in the specification do not mean that all the features and advantages that can be realized by the present invention should be in any single specific embodiment of the present invention. Rather, it should be understood that the expression of related features and advantages means that the specific features, advantages, or characteristics described in conjunction with specific embodiments are included in at least one specific embodiment of the present invention. Therefore, the discussion of features and advantages, and similar expressions in the specification is related to the same specific embodiment, but it is not necessary.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating a virtual office system and a user device for creating a virtual office according to a preferred embodiment of the present invention;

FIG. 2 is a flowchart of a method of creating virtual office for remote work according to a first embodiment of the present invention; and

FIG. 3 is a flowchart of a method of creating virtual office for remote work according to a second embodiment of the present invention.

### DETAILED DESCRIPTION OF THE INVENTION

In order to make the description of the present disclosure more detailed and complete, the following provides an illustrative description for the implementation aspects and specific embodiments of the present invention; but this is not the only way to implement or use specific embodiments of the present invention. The implementation manners cover the characteristics of a number of specific embodiments and the steps and sequences of the method used to construct and operate these specific embodiments. However, other specific embodiments can also be used to achieve the same or equal functions and sequence of steps.

The present invention provides a method of creating virtual office for remote work, which generates a virtual office identification code that is permanently exclusive to a user. It is convenient for the user to provide clients to communicate with the user without changing the virtual office identification code from time to time. The method can limit the number of invited clients who enter the electronic conference when the clients participate in the same electronic conference. Besides, the method can also individually identify the invited clients that enter the electronic conference.

Before describing the content of the present invention, the definitions of related nouns will be explained as follows:

Virtual office identification code: The virtual office identification code, which is composed of symbols, texts, and numbers, is permanently exclusive to a user. A client uses the virtual office identification code to communicate with the user.
Access code: The access code, which is composed of symbols, texts, and numbers and set by the user, is provided to the client to enter an electronic conference. If each invited client needs to be identified, different access codes corresponding to different clients will be set. If the invited clients need not to be identified, the same access code corresponding to a group of invited clients will be set.
User: The user is a man/woman who has an exclusive virtual office identification code provided by a virtual office system. The user has a permission to set access codes corresponding to different invited clients or to set the same access code corresponding to a group of clients.
Client: The client is a man/woman who wants to communicate with the user. The client enters an electronic conference to communicate with the user based on the virtual office identification code and the access code.
Virtual office system: The virtual office system is a computer system, which creates a virtual office and an electronic conference thereof provided to the client to communicate with the user. The virtual office system provides a virtual office identification code that is permanently exclusive to each user.
User device: The user device is an electronic device operated by the user. The user can set an access code that is published to anyone through the user device, or set a specific access code for specific clients.

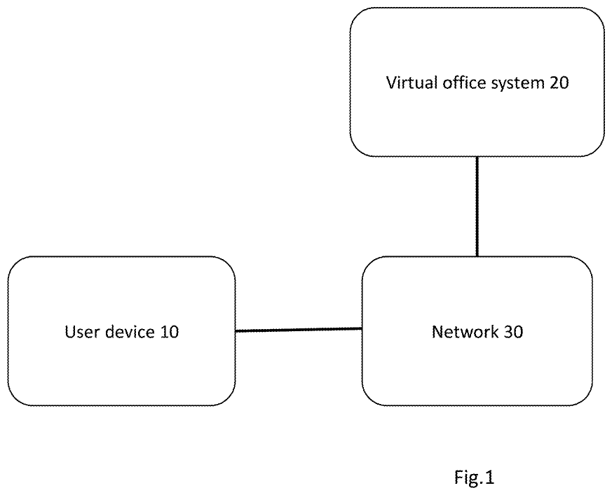

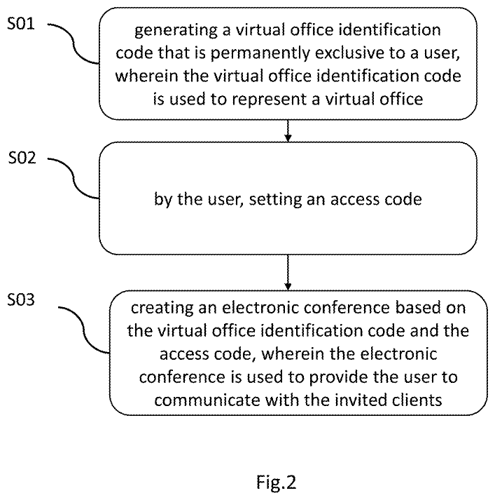

Please refer to FIG. 1 and FIG. 2 in cooperation with the following description. FIG. 1 is a schematic diagram illustrating a virtual office system and a user device for creating a virtual office according to a preferred embodiment of the present invention. FIG. 2 is a flowchart of a method of creating virtual office for remote work according to a first embodiment of the present invention. In FIG. 1, a user device 10 can be, for example, but not limited to a smart phone, a tablet computer, a notebook computer, or a desk computer. A virtual office system 20 can be a computer server or composed of a group of computers. The user device 10 is connected to the virtual office system 20 through a network 30.

FIG. 2 shows the method of creating virtual office for remote work. In Step S01, a virtual office identification code that is permanently exclusive to a user is generated, wherein the virtual office identification code is used to represent a virtual office. The virtual office identification code may be composed of symbols, texts, and numbers. In the present invention, the virtual office system 20 generates the virtual office identification code. In Step S02, the user sets an access code. The access code may be also composed of symbols, texts, and numbers. The user can set the access code through a user device 20. In Step S03, an electronic conference is created based on the virtual office identification code and the access code. The electronic conference is used to provide the user to communicate with the invited clients. In the present invention, the virtual office system 20 creates the electronic conference is created based on the virtual office identification code and the access code. The electronic conference includes a video conference, a voice conference, or a text conference.

In an embodiment of the present invention, the user can set an access code that is published to anyone. Thus, anyone can enter the electronic conference to communicate with the user based on the virtual office identification code and the access code. The embodiment is similar to a fact that anyone who knows the phone number of a company and the extension number of the contact person can contact that person in the traditional business environment. In other words, when the user works in the company or at home, any clients (including colleagues) can contact the user and have discussions in the electronic conference with the virtual office identification code and the public access code.

In Step S02, the user can set the number of invited clients who can enter the electronic conference. Besides, in Step S02, the user also set whether the electronic conference needs permission to enter. This way, the system displays a notification to the user when the user is discussing matters with client A in an electronic conference and client B asks to enter the electronic conference. Thus, the user can determine whether to allow or deny client B to enter the electronic conference.

In another embodiment of the present invention, if the user wants to communicate with a specific group of invited clients without identifying each client in the group (for example, the user wants to hold a conference with multiple colleagues in the research and development department), the user can set another access code through the user device 20. This new access code is only available for invited clients of the group (for example, multiple colleagues in the research and development department). Therefore, if one or more customers enter an electronic conference with this new access code, the user can know that one or more colleagues of the research and development department have entered the electronic conference. In other words, in the embodiment, the user can set a new access code for a group of colleagues, thereby identifying the client entering the electronic conference.

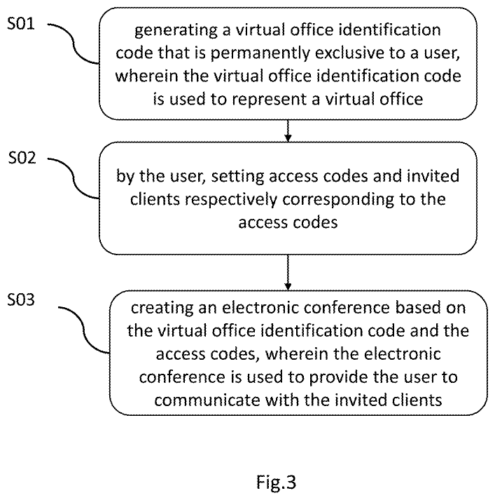

FIG. 3 is a flowchart of a method of creating virtual office for remote work according to a second embodiment of the present invention. In Step S01, a virtual office identification code that is permanently exclusive to a user is generated, wherein the virtual office identification code is used to represent a virtual office. In Step S02, the user sets access codes and invited clients respectively corresponding to the access codes. It should be understood that the user sets each of the access codes corresponding to an invited client in Step S02. Alternatively, in Step S02, the user sets one of the access codes corresponding to an invited client and sets another of the access codes corresponding to a group of clients, such that each access code is set to correspond to a client or a group of clients. In Step S03, an electronic conference is created based on the virtual office identification code and the access codes, wherein the electronic conference is used to provide the user to communicate with the invited clients. In the embodiment, each client or each group of clients entering the electronic conference can be identified according to their access code since the access code is set to be exclusive to each client or each group of clients.

In the present invention, after the user sets access codes exclusive to invited clients (e.g., clients have different access codes or a group of client has the same access code), the user informs each client of his/her access code by messages or e-mails.

According to the forgoing description, it is understood that the present invention provides a method of creating virtual office for remote work, which generates a virtual office identification code that is permanently exclusive to a user. It is convenient for the user to provide clients to communicate with the user without changing the virtual office identification code from time to time. The method can limit the number of invited clients who can enter the electronic conference when the clients participate in the same electronic conference. Besides, the method can also individually identify the invited clients that enter the electronic conference.

Although various examples of the disclosed technology have been described above, it should be understood that these examples have been presented by examples rather than limited. Likewise, various drawings may depict example architectures or other configurations of the disclosed technology. The drawings may be depicted to assist in understanding the features and functionality that may be included in the disclosed technology. The disclosed technology is not limited to the illustrated example architectures or configurations, but the desired features can be implemented using a variety of alternative architectures and configurations. In fact, it will be obvious to those skilled in the art to know how to implement alternative functionalities, logical or physical partitions and configurations to implement the required features of the technology disclosed in this article. In addition, with regard to flowcharts, operation descriptions, and methodological technical solutions, the order in which the steps are presented herein should not require that the disclosed technologies be implemented in the same order to perform the listed functionality, unless the context dictates otherwise.

What is claimed is:

1. A method of creating virtual office for remote work comprising:
(A) generating a virtual office identification code that is permanently exclusive to a user, wherein the virtual office identification code is used to represent a virtual office;
(B) by the user, setting an access code; and
(C) creating an electronic conference based on the virtual office identification code and the access code, wherein the electronic conference is used to provide the user to communicate with the invited clients.

2. The method of creating virtual office for remote work according to claim 1, wherein in operation (B), the user sets number of the invited clients who enter the electronic conference.

3. The method of creating virtual office for remote work according to claim 1, wherein in operation (B), the user sets whether the electronic conference needs permission to enter.

4. The method of creating virtual office for remote work according to claim 1, wherein in operation (B), the user sets a group of invited clients corresponding to the access code.

5. The method of creating virtual office for remote work according to claim 1, wherein the electronic conference comprises a video conference, a voice conference, or a text conference.

6. A method of creating virtual office for remote work comprising:
(A) generating a virtual office identification code that is permanently exclusive to a user, wherein the virtual office identification code is used to represent a virtual office;
(B) by the user, setting access codes and invited clients respectively corresponding to the access codes; and
(C) creating an electronic conference based on the virtual office identification code and the access codes, wherein the electronic conference is used to provide the user to communicate with the invited clients.

7. The method of creating virtual office for remote work according to claim 6, wherein one of the access codes corresponds to an invited client.

8. The method of creating virtual office for remote work according to claim 6, wherein one of the access codes corresponds to a group of invited clients.

9. The method of creating virtual office for remote work according to claim 6, wherein each of the access codes corresponds to an invited client.

10. The method of creating virtual office for remote work according to claim 6, further comprising a step of identifying the invited clients based on the access codes for the electronic conference.
